(19) United States
(12) Patent Application Publication
(10) Pub. No.: US 2015/0378026 A1
(43) Pub. Date: Dec. 31, 2015

(54) POSITIONING APPARATUS, POSITIONING METHOD, AND RECORDING MEDIUM

(71) Applicant: CASIO COMPUTER CO., LTD., Tokyo (JP)

(72) Inventor: Yutaka ONODERA, Tokyo (JP)

(73) Assignee: CASIO COMPUTER CO., LTD., Tokyo (JP)

(21) Appl. No.: 14/666,267

(22) Filed: Mar. 23, 2015

(30) Foreign Application Priority Data
Jun. 30, 2014 (JP) 2014-134534

(51) Int. Cl. G01S 19/24

(52) U.S. Cl. CPC G01S 19/24

(57) ABSTRACT

Provided is a positioning apparatus for determining positions including: a distance acquisition unit configured to acquire pseudo-range information pieces indicating pseudo-ranges from the positioning apparatus to three positioning satellites; an altitude acquisition unit configured to acquire the altitude of the position of the positioning apparatus based on map information; a setting unit configured to set the altitude acquired by the altitude acquisition unit as a tentative altitude at the position of the positioning apparatus; and a positioning unit configured to perform a positioning process in a two-dimensional positioning method based on the pseudo-range information acquired by the distance acquisition unit, and the tentative altitude.

### BACKGROUND OF THE INVENTION

The present invention relates to a positioning apparatus, a positioning method, and a recording medium.

### DESCRIPTION OF THE RELATED ART

For example, an apparatus is conventionally known which determines a position using global navigation satellite system (GNSS) such as global positioning system (GPS). For example, a positioning apparatus of JP 2007-256041 A determines four unknowns, “latitude”, “longitude”, “altitude”, and “time error” based on distance information (pseudo-range information) from a receiving point of a signal transmitted from a positioning satellite to the positioning satellite, and the location information of a plurality of positioning satellites.

A positioning process by the positioning apparatus includes, for example, a three-dimensional positioning mode (3D Fix) using signals respectively transmitted from four or more positioning satellites, and a two-dimensional positioning mode (2D Fix) using signals respectively transmitted from three positioning satellites.

In the three-dimensional positioning mode, four or more pieces of pseudo-range information are used to calculate three-dimensional coordinates (x, y, z) of the current location where the positioning apparatus is. On the other hand, in the two-dimensional positioning mode, three pieces of pseudo-range information and tentative altitude information are used to calculate two-dimensional coordinates (x, y) excluding the altitude of the current position.

However, in the two-dimensional positioning mode, if there is a large difference between the altitude set as the tentative altitude information and the actual altitude, the positioning accuracy of the calculated two-dimensional coordinates (x, y) of the current position is decreased as compared to the three-dimensional positioning mode. In other words, the positioning accuracy of the two-dimensional positioning mode depends on the accuracy of the tentative altitude information. Accordingly, it is desired to preset a more accurate altitude as the tentative altitude information.

### BRIEF SUMMARY OF THE INVENTION

Hence, an issue of the present invention is to provide a positioning apparatus, positioning method, and recording medium that can increase the accuracy of the positioning process in the two-dimensional positioning mode.

According to an embodiment of the present invention, provided is a positioning apparatus for determining positions, including: a distance acquisition unit configured to acquire pseudo-range information pieces indicating pseudo-ranges from the positioning apparatus to three positioning satellites; an altitude acquisition unit configured to acquire the altitude of the position of the positioning apparatus based on map information; a setting unit configured to set the altitude acquired by the altitude acquisition unit as a tentative altitude at the position of the positioning apparatus; and a positioning unit configured to perform a positioning process in a two-dimensional positioning method based on the pseudo-range information acquired by the distance acquisition unit, and the tentative altitude.

According to an embodiment of the present invention, provided is a positioning method using a positioning apparatus, including the steps of: acquiring pseudo-range information pieces indicating pseudo-ranges from the positioning apparatus to three positioning satellites; acquiring the altitude of the position of the positioning apparatus from the outside; setting the acquired altitude as a tentative altitude at the position of the positioning apparatus; and performing a positioning process in a two-dimensional positioning method based on the acquired pseudo-range information and the tentative altitude.

According to an embodiment of the present invention, provided is a non-transitory computer-readable recording medium recording a program for causing a computer of a positioning apparatus to execute: a distance acquisition function of acquiring pseudo-range information pieces indicating pseudo-ranges from the positioning apparatus to three positioning satellites; an altitude acquisition function of acquiring the altitude of the position of the positioning apparatus from the outside; a setting function of setting the altitude acquired by the altitude acquisition function, as a tentative altitude at the position of the positioning apparatus; and a positioning function of performing a positioning process in a two-dimensional positioning method based on the pseudo-range information acquired by the distance acquisition function, and the tentative altitude.

### BRIEF DESCRIPTION OF THE SEVERAL VIEWS OF THE DRAWING

FIG. 1 is a block diagram illustrating a schematic configuration of a positioning apparatus of one embodiment to which the present invention has been applied;

FIG. 2 is a flowchart illustrating an example of operations related to a positioning process by the positioning apparatus of FIG. 1;

FIG. 3 is a flowchart illustrating an example of operations related to an altitude acquisition process by the positioning apparatus of FIG. 1; and

FIG. 4 is a diagram illustrating the positioning process of FIG. 2.

### DETAILED DESCRIPTION OF THE INVENTION

Hereinafter, a specific aspect of the present invention is described using the drawings. However, the scope of the invention is not limited to illustrated examples.

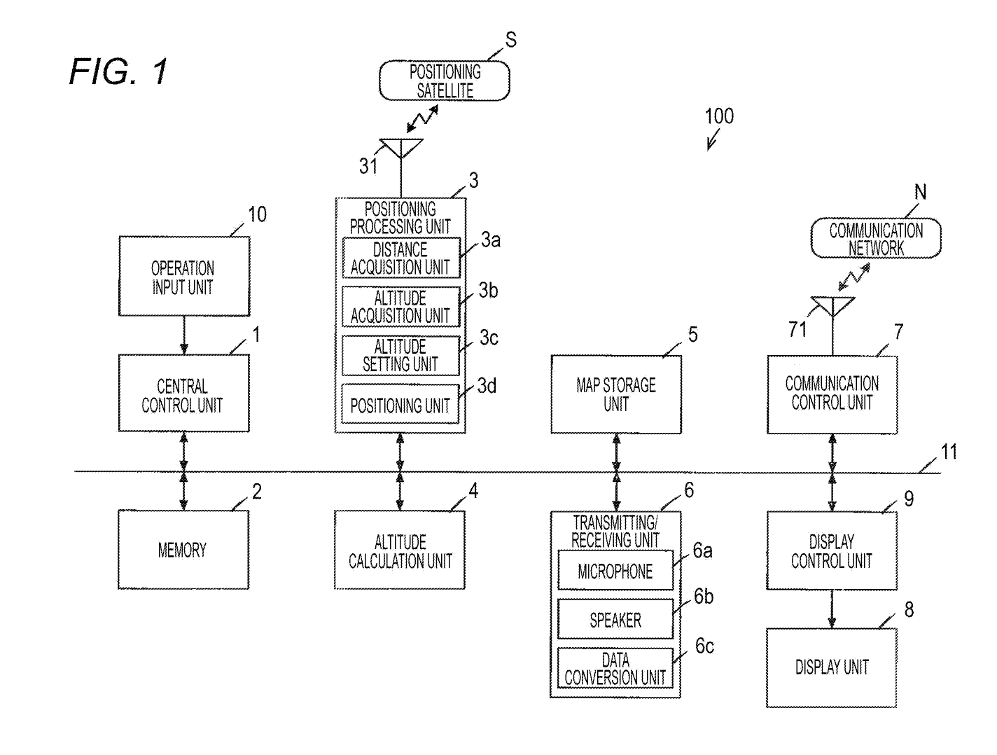

FIG. 1 is a block diagram illustrating a schematic configuration of a positioning apparatus 100 of one embodiment to which the present invention has been applied.

As illustrated in FIG. 1, the positioning apparatus 100 includes a central control unit 1, a memory 2, a positioning processing unit 3, an altitude calculation unit 4, a map storage unit 5, a transmitting/receiving unit 6, a communication control unit 7, a display unit 8, a display control unit 9, and an operation input unit 10.

Moreover, the central control unit 1, the memory 2, the positioning processing unit 3, the altitude calculation unit 4, the map storage unit 5, the transmitting/receiving unit 6, the communication control unit 7, and the display control unit 9 are connected via a bus line 11.

The positioning apparatus 100 is configured of, for example, a mobile station, such as a mobile phone or PHS (Personal Handy-phone System), used in a mobile communication network, or a PDA (Personal Data Assistant).

The central control unit 1 controls each unit of the positioning apparatus 100.

Specifically, the central control unit 1 includes a central processing unit (CPU; illustration omitted) that controls each unit of the positioning apparatus 100, a random access memory (RAM), and a read only memory (ROM), and performs various control operations in accordance with various process programs for the positioning apparatus 100 (illustration omitted).

The memory 2 is configured of, for example, a dynamic random access memory (DRAM). For example, data to be processed by each unit of the positioning apparatus 100, in addition to the central control unit 1, is temporarily stored in the memory 2.

The positioning processing unit 3 uses global navigation satellite system (GNSS) such as global positioning system (GPS) to determine the position of the positioning apparatus.

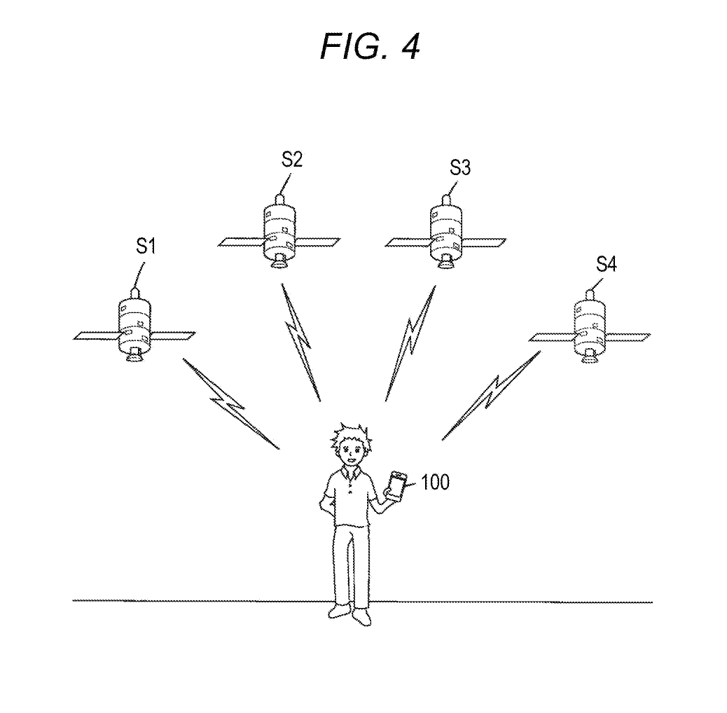

In other words, the positioning processing unit 3 receives, for example, signals (for example, ranging codes such as the coarse and acquisitions (C/A) code and precise (P) code, and the navigation messages such as almanac information (general orbit information) and ephemeris information (detailed orbit information)) transmitted from a plurality of positioning satellites S (FIG. 4 illustrates only four positioning satellites S1 to S4) launched into a low Earth orbit, at a receiving antenna 31 at predetermined timings. The positioning processing unit 3 then performs a positioning process that determines a three-dimensional current position (latitude, longitude, altitude) of the positioning apparatus in the three-dimensional positioning mode (3D Fix) or two-dimensional positioning mode (2D Fix), based on the received signals.

Specifically, the positioning processing unit 3 includes a distance acquisition unit 3a, an altitude acquisition unit 3b, an altitude setting unit 3c, and a positioning unit 3d.

Each unit of the positioning processing unit 3 is configured of, for example, a predetermined logic circuit. However, this configuration is an example. The configuration is not limited to this example.

The distance acquisition unit 3a acquires pseudo-range information.

In other words, the distance acquisition unit 3a performs a predetermined computation based on the ranging code included in the signal received by the receiving antenna 31, calculates a pseudo-range to each positioning satellite S, and acquires each pseudo-range information piece. Specifically, in the case of, for example, the three-dimensional positioning mode, the distance acquisition unit 3a calculates pseudo-ranges from the positioning apparatus to four or more positioning satellites S, and acquires the respective pseudo-range information pieces. Moreover, in the case of, for example, the two-dimensional positioning mode, the distance acquisition unit (distance acquisition unit) 3a calculates pseudo-ranges from the positioning apparatus to three positioning satellites S, and acquires the respective pseudo-range information pieces.

The altitude acquisition unit 3b acquires the altitude of the position of the positioning apparatus upon the positioning process.

In other words, the altitude acquisition unit 3b acquires the altitude of the position of the positioning apparatus calculated by the altitude calculation unit (described in detail below) 4, and stored in the memory 2. Moreover, whenever the altitude calculation unit 4 calculates the altitude of the position of the positioning apparatus, the altitude acquisition unit 3b acquires the calculated altitude from the memory 2.

The altitude setting unit (setting unit) 3c sets the altitude of the position of the positioning apparatus acquired by the altitude acquisition unit 3b, as tentative altitude information.

In other words, if the positioning process is performed in the two-dimensional positioning mode, the altitude setting unit 3c cannot calculate the altitude of the position of the positioning apparatus. Accordingly, there is a need to preset the tentative altitude information. Specifically, if, for example, the altitude acquisition unit 3b has not acquired the altitude of the position of the positioning apparatus (for example, if the positioning process is performed immediately after startup), the altitude setting unit 3c sets the altitude specified in advance as default (for example, “0 m”) as the tentative altitude information. On the other hand, if the altitude acquisition unit 3b has acquired the altitude of the position of the positioning apparatus, the altitude setting unit 3c sets the acquired altitude as the tentative altitude information. At this point in time, whenever the altitude acquisition unit 3b acquires the altitude of the position of the positioning apparatus, the altitude setting unit 3c sets the acquired altitude as the tentative altitude information.

The positioning unit 3d determines the position of the positioning apparatus.

In other words, the positioning unit 3d performs predetermined computations based on the navigation messages (for example, ephemeris information) included in the signals received by the receiving antenna 31, and calculates the positions of the positioning satellites S. For example, in the case of, for example, the three-dimensional positioning mode, the positioning unit 3d performs predetermined computations based on pseudo-range information pieces corresponding to four or more positioning satellites S acquired by the distance acquisition unit 3a, and the calculated positions of the positioning satellites S, and accordingly calculates the three-dimensional coordinates (x, y, z) of the position of the positioning apparatus, and an error in the clock of the positioning apparatus.

Moreover, in the case of, for example, the two-dimensional positioning mode, the positioning unit (positioning unit) 3d performs predetermined computations based on pseudo-range information pieces corresponding to three positioning satellites S acquired by the distance acquisition unit 3a, the tentative altitude information set by the altitude setting unit 3c, and the calculated positions of the positioning satellites S, and accordingly calculates the two-dimensional coordinates (x, y) of the position of the positioning apparatus, and an error in the clock of the positioning apparatus. At this point in time, if the altitude acquisition unit 3b has acquired the altitude of the position of the positioning apparatus, in other words, the altitude calculated by the altitude calculation unit 4, the altitude setting unit 3c sets the acquired altitude as the tentative altitude information. The positioning unit 3d then performs the positioning process in the two-dimensional positioning mode by use of the tentative altitude information set by the altitude setting unit 3c.

Moreover, the positioning unit 3d generates location information (for example, coordinate information of latitude, longitude, and latitude) related to the calculated position. The location information on the position of the positioning apparatus generated by the positioning unit 3d may be output to the memory 2, and temporarily stored in the memory 2.

The altitude calculation unit (altitude calculation unit) 4 calculates the altitude of the position of the positioning apparatus (an altitude calculation process).

In other words, the altitude calculation unit 4 checks the position of the positioning apparatus on a map of the map storage unit 5, and calculates the altitude of the position of the positioning apparatus based on the check result. Specifically, the altitude calculation unit 4 checks the two-dimensional coordinates (latitude, longitude) of the position of the positioning apparatus on the map stored in the map storage unit 5, based on the location information obtained from the positioning processing unit 3. The altitude calculation unit 4 then acquires the coordinate information of the altitude associated with the checked location from the map storage unit 5, and calculates the coordinate information as the altitude of the position of the positioning apparatus.

The altitude of the position of the positioning apparatus calculated by the altitude calculation unit 4 may be output to the memory 2, and temporarily stored in the memory 2.

Moreover, a method for checking a location on a map is a known technique. Therefore, its detailed description is omitted here.

The map storage unit 5 configures a storage unit where a map is stored.

In other words, the map storage unit 5 is configured of, for example, a hard disk drive (HDD) or solid state drive (SSD). A map associated with three-dimensional position coordinates is databased and stored in the map storage unit 5. Specifically, in the map storage unit 5, map information indicating address information such as administrative divisions including prefectures, cities, towns, and villages, and house numbers, information related to buildings, facilities, stores, parks, and railways, topographic information, and road information is associated with coordinate information such as latitude, longitude, and altitude.

The above map storage unit 5 is an example. The map storage unit 5 is not limited to the example. The contents of information databased in the map storage unit 5, and the like can be freely changed as appropriate. Moreover, the map storage unit 5 may be configured to acquire a map from an external device (for example, a server; illustration omitted) connected via a communication network N, and store the map.

The transmitting/receiving unit 6 makes a call to an external user of an external device connected via the communication network N.

Specifically, the transmitting/receiving unit 6 includes a microphone 6a, a speaker 6b, and a data conversion unit 6c. The transmitting/receiving unit 6 then performs an A/D conversion process on a user's outgoing voice input from the microphone 6a by the data conversion unit 6c, and outputs the outgoing voice data to the central control unit 1 while performing a D/A conversion process on voice data such as incoming voice data output and input from the communication control unit 7 by the data conversion unit 6c, and outputting the voice data from the speaker 6b, under the control of the central control unit 1.

The communication control unit 7 transmits and receives data via the communication network N and a communication antenna 71.

In other words, the communication antenna 71 is an antenna that can transmit and receive data corresponding to a predetermined communication method (for example, a wideband code division multiple access (W-CDMA) method, or a global system for mobile communications; registered trademark (GSM) method) adopted by the positioning apparatus 100 in communication with a wireless base station (illustration omitted). The communication control unit 7 transmits and receives data to and from the wireless base station via the communication antenna 71 on a communication channel set in a predetermined communication method in accordance with a communication protocol corresponding to the communication method. In other words, the communication control unit 7 transmits and receives voice during a call to an external user of an external device, and transmits and receives the data of emails, to and from the external device on the other end, based on instruction signals output and input from the central control unit 1.

The configuration of the communication control unit 7 is an example. The configuration is not limited to the example, and can be freely changed as appropriate. For example, although the illustration is omitted, a wireless LAN module may be mounted to make the communication network N accessible via an access point (Access Point).

The communication network N is, for example, a communication network that connects the positioning apparatus 100 to an external device via a wireless base station, a gateway server (illustration omitted), and the like.

Moreover, the communication network N is, for example, a communication network constructed using a dedicated line and existing general public line. Various line forms such as a local area network (LAN) and wide area network (WAN) are applicable. Moreover, the communication network N includes, for example, various communication networks such as a telephone network, an ISDN network, a dedicated line, a mobile communication network, a communication satellite line, and a CATV network, an IP network, a voice over internet protocol (VoIP) gateway, and an Internet service provider.

The display unit 8 includes, for example, an LCD, and displays various pieces of information in a display area under the control of the CPU of the central control unit 1. Specifically, the display unit 8 displays, in the display area, for example, an application screen (for example, a map screen or a Web page screen) in accordance with an image signal output from the display control unit 9.

The display control unit 9 generates application screens based on the execution of various application programs (illustrations omitted) by the CPU of the central control unit 1, and outputs image signals in accordance with the generated application screens to the display unit 8.

Examples of the application programs include map display software, email software, an Internet browser, a messenger, game software, electronic dictionary software, a word processor, spreadsheet software, presentation software, image edition software, drawing software, a vector graphic editor, and programs of digital camera control.

Moreover, the application program may be, for example, prerecorded in the ROM, or acquired by the communication control unit 7 from an external device (illustration omitted) via the communication network N.

The operation input unit 10 is for inputting various instructions into the positioning apparatus.

Specifically, the operation input unit 10 includes a power button related to the turning on/off of the power to the positioning apparatus, up, down, left, and right cursor buttons and decision button related to instructions to select a mode, function, and the like, a communication-related button related to instructions to execute outgoing and incoming calls and the transmission/reception of emails, and various buttons such as numeric buttons and symbol buttons related to instructions to input text (the illustration of any of which is omitted).

When a user operates various buttons, the operation input unit 10 outputs operation instructions in accordance with the operated buttons to the central control unit 1. The central control unit 1 causes the units to execute predetermined operations (for example, making and receiving calls, and transmitting and receiving emails) in accordance with the operation instructions output and input from the operation input unit 10.

The operation input unit 10 may include a touch panel provided integrally with the display unit 8, and may output, to the central control unit 1, an operation instruction in accordance with a predetermined operation on the touch panel by the user based on the predetermined operation.

Next, various processes to be executed by the positioning apparatus 100 are described with reference to the drawings.

### <The Positioning Process>

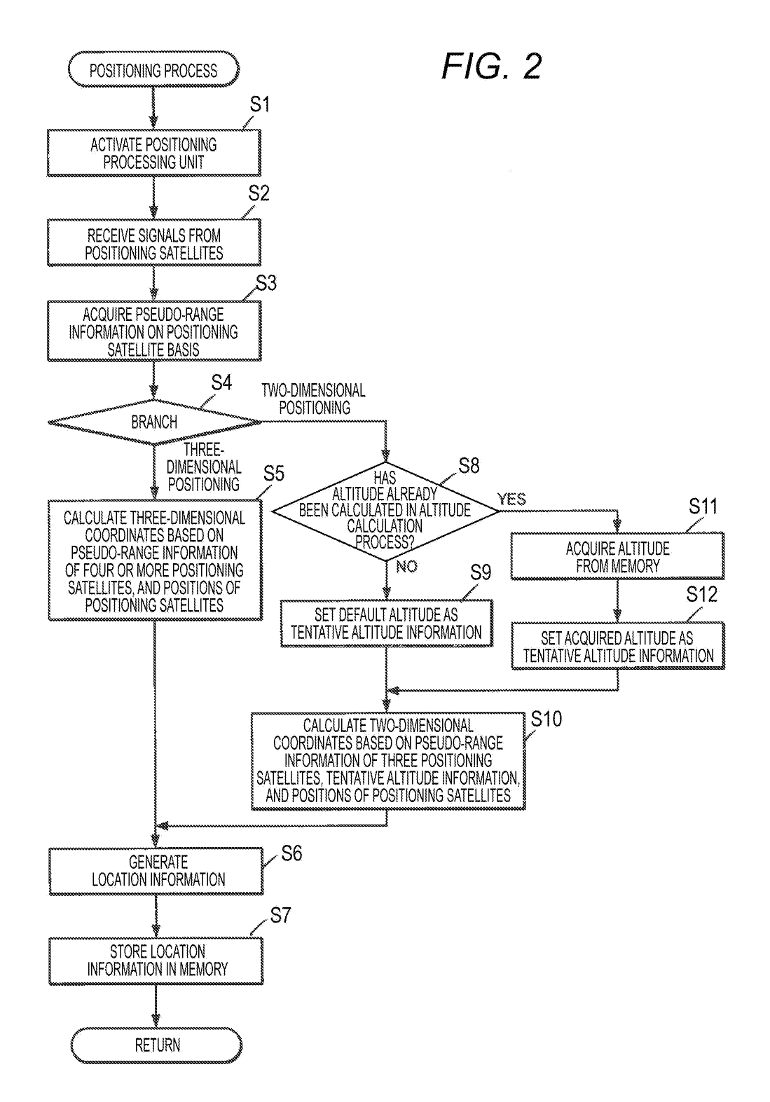

Firstly, the positioning process is described with reference to FIG. 2.

FIG. 2 is a flowchart illustrating an example of operations related to the positioning process by the positioning apparatus 100.

As illustrated in FIG. 2, the CPU of the central control unit 1 transmits a predetermined control signal to the positioning processing unit 3, and activates the positioning processing unit 3 (Step S1). Specifically, when, for example, executing a predetermined application program (for example, map display software) in accordance with a predetermined operation by the user on the operation input unit 10, the CPU of the central control unit 1 activates the positioning processing unit 3 if a need to determine the position of the positioning apparatus arises.

The positioning processing unit 3 receives signals (for example, ranging codes and navigation messages) transmitted from a plurality of positioning satellites S at the receiving antenna 31 at predetermined timings (for example, at intervals of one second) (Step S2). The distance acquisition unit 3a then performs predetermined computations based on the ranging codes included in the signals received by the receiving antenna 31, calculates pseudo-ranges to the positioning satellites S, and acquires pseudo-range information pieces (Step S3).

Next, the positioning processing unit 3 branches the process in accordance with the mode of the positioning process (Step S4).

Specifically, the positioning processing unit 3 determines whether to perform the positioning process in the three-dimensional positioning mode or two-dimensional positioning mode in accordance with, for example, the number of pieces of the pseudo-range information acquired by the distance acquisition unit 3a, the reliability of the pseudo-range information, the electric wave intensity of a signal transmitted from the positioning satellite S, and the arrangement state of the positioning satellites S. The positioning processing unit 3 then branches the process.

For example, as the number of the positioning satellites S from which signals are received is increased, and as the positioning satellite S with a higher electric wave intensity of a signal is used for the positioning process, and as the arrangement of the positioning satellites S becomes more sparse, it is considered to increase positioning accuracy. Accordingly, the positioning processing unit 3 determines the mode of the positioning process, considering them.

### <The Three-Dimensional Positioning Mode>

If the positioning process is performed in the three-dimensional positioning mode (Step S4; three-dimensional positioning), the positioning unit 3d performs predetermined computations based on the navigation messages (for example, the ephemeris information), calculates the positions of the positioning satellites S, and then performs predetermined computations based on the pseudo-range information pieces corresponding to the four or more positioning satellites S (for example, the positioning satellites S1 to S4) acquired by the distance acquisition unit 3a, and the positions of the positioning satellites S. Accordingly, the three-dimensional coordinates (x, y, z) of the position of the positioning apparatus is calculated (Step S5).

The positioning unit 3d subsequently generates location information related to the calculated position of the positioning apparatus (Step S6). The positioning unit 3d then outputs the generated location information to the memory 2, and stores the location information in the memory 2 (Step S7).

### <The Two-dimensional Positioning Mode>

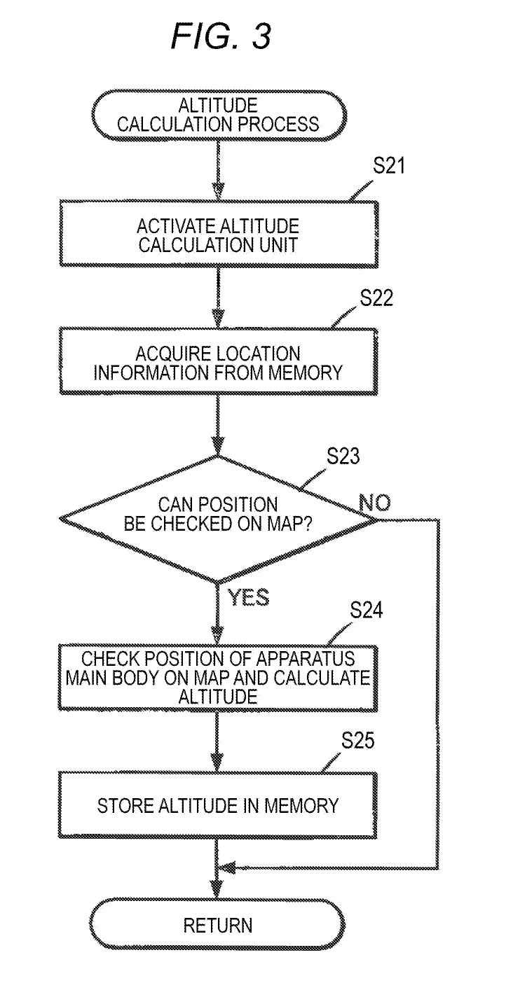

If the positioning process is performed in the two-dimensional positioning mode (Step S4; two-dimensional positioning), the CPU of the central control unit 1 determines first whether or not the altitude calculation process (refer to FIG. 3; described below) was executed by the altitude calculation unit 4 and the altitude has already been calculated (Step S8).

Here, if it is determined that the altitude has not been calculated yet (Step S8; NO), the altitude setting unit 3c sets the altitude specified in advance as default (for example, “0 m”) as the tentative altitude information (Step S9).

Next, the positioning unit 3d performs predetermined computations based on the navigation messages (for example, the ephemeris information), calculates the positions of the positioning satellites S, and then performs predetermined computations based on the pseudo-range information pieces corresponding to the three positioning satellites S (for example, the satellites S1 to S3) acquired by the distance acquisition unit 3a, the tentative altitude information set by the altitude setting unit 3c, and the positions of the positioning satellites S. Accordingly, the two-dimensional coordinates (x, y) of the position of the positioning apparatus are calculated (Step S10).

In this case, if there is a large difference between the default altitude set as the tentative altitude information and the actual altitude, the positioning accuracy of the calculated two-dimensional coordinates (x, y) of the position of the positioning apparatus is decreased.

On the other hand, it is determined in Step S8 that the altitude has already been calculated (Step S8; YES), the altitude acquisition unit 3b acquires, from the memory 2, the altitude of the position of the positioning apparatus calculated by the altitude calculation unit 4 in the altitude calculation process (Step S11). Next, the altitude setting unit 3c sets the altitude acquired by the altitude acquisition unit 3b as the tentative altitude information (Step S12).

Next, the CPU of the central control unit 1 shifts the processing to Step S10. Substantially similarly to the above description, the positioning unit 3d performs predetermined computations based on the navigation messages (for example, the ephemeris information), calculates the positions of the positioning satellites S, and then performs predetermined computations based on the pseudo-range information pieces corresponding to the three positioning satellites S acquired by the distance acquisition unit 3a, the tentative altitude information set by the altitude setting unit 3c, and the positions of the positioning satellites S. Accordingly, the two-dimensional coordinates (x, y) of the position of the positioning apparatus are calculated (Step S10).

In this case, the altitude set as the tentative altitude information is the altitude calculated by the altitude calculation unit 4 in the altitude calculation process. Accordingly, it is possible to prevent a decrease in the positioning accuracy of the calculated two-dimensional coordinates (x, y) of the position of the positioning apparatus as compared to the case of setting default altitude.

After the process of Step S10, the CPU of the central control unit 1 shifts the processing to Step S6. The positioning unit 3d generates location information related to the position of the positioning apparatus as in the three-dimensional positioning mode (Step S6). The generated location information is stored in the memory 2 (Step S7).

The above processing is repeatedly executed until the CPU of the central control unit 1 transmits, to the positioning processing unit 3, a control signal to stop the positioning process and the positioning processing unit 3 stops the positioning process.

### <The Altitude Calculation Process>

Next, the altitude calculation process is described with reference to FIG. 3.

FIG. 3 is a flowchart illustrating an example of operations related to the altitude calculation process by the positioning apparatus 100.

As illustrated in FIG. 3, the CPU of the central control unit 1 transmits a predetermined control signal to the altitude calculation unit 4, and activates the altitude calculation unit 4 (Step S21). Specifically, for example, the CPU of the central control unit 1 monitors the storage content of the memory 2, and activates the altitude calculation unit 4 whenever new location information is stored in the memory 2.

Next, the altitude calculation unit 4 acquires, from the memory 2, the location information related to the position of the positioning apparatus, which has been generated in the positioning process (Step S22), and determines whether or not a check on the map is possible, from the content of the location information (for example, the reliability of the location information) (Step S23).

Here, if it is determined that a check on the map is possible (Step S23; YES), the altitude calculation unit 4 checks the two-dimensional coordinates (latitude, longitude) of the position of the positioning apparatus on the map stored in the map storage unit 5 based on the location information, and calculates the altitude of the position of the positioning apparatus based on the check result (Step S24).

The altitude calculation unit 4 then outputs, to the memory 2, the calculated altitude of the position of the positioning apparatus. The altitude is stored in the memory 2 (Step S25).

On the other hand, if it is determined in Step S23 that a check on the map is not possible (Step S23; NO), the altitude calculation unit 4 skips the processes of Steps S24 and S25 and ends the altitude calculation process.

The positioning apparatus 100 is configured to be able to execute the positioning process (refer to FIG. 2) and the altitude calculation process (refer to FIG. 3) independently and respectively at predetermined timings under the control of the CPU of the central control unit 1, which is an example. The configuration is not limited to the example. The positioning apparatus 100 may be configured to be able to execute the positioning process and the altitude calculation process as a series of processes.

In other words, for example, it may be configured in such a manner as that whenever generating location information in the positioning process, the positioning processing unit 3 outputs the generated location information to the altitude calculation unit 4 while whenever calculating an altitude in the altitude calculation process, the altitude calculation unit 4 outputs the calculated altitude to the positioning processing unit 3.

As described above, according to the positioning apparatus 100 in the embodiment, the altitude of the position of the positioning apparatus is acquired from the outside upon the positioning process, and the acquired altitude is set as the tentative altitude information. Accordingly, the set tentative altitude information is used to perform the positioning process in the two-dimensional positioning mode. Therefore, a decrease in the positioning accuracy of the calculated two-dimensional coordinates (x, y) of the position of the positioning apparatus can be prevented as compared to the case of setting the altitude specified as default as the tentative altitude information.

In other words, the positioning accuracy of the two-dimensional positioning mode depends on the accuracy of the tentative altitude information. Accordingly, if there is a large difference between the altitude specified as default and the actual altitude, as long as the positioning process is executed in the two-dimensional positioning mode, the positioning accuracy cannot be increased. Hence, a more accurate altitude of the position of the positioning apparatus is set as the tentative altitude information upon the positioning process. Accordingly, the tentative altitude information is used to enable the execution of the positioning process in the two-dimensional positioning mode. Accordingly, the positioning accuracy can be increased.

Specifically, the position of the positioning apparatus determined by the positioning process is checked on the map stored in the map storage unit 5. Accordingly, a more accurate altitude of the position of the positioning apparatus can be calculated. Therefore, the calculated altitude can be set as the tentative altitude information. Consequently, a more accurate altitude can be used as the tentative altitude information in a future positioning process in the two-dimensional positioning mode.

Moreover, the altitude of the position of the positioning apparatus is acquired upon every positioning process. The acquired altitudes are set sequentially as the tentative altitude information. Therefore, the content of the tentative altitude information is updated sequentially so that the accuracy can be increased. In other words, if, for example, the position of the positioning apparatus is checked on the map to calculate the altitude, the process of checking the position on the map is repeatedly executed. Accordingly, the accuracy of the check can be increased. As a result, the accuracy of the altitude of the position of the positioning apparatus can be further increased. Consequently, the accuracy of the tentative altitude information used in the positioning process in the two-dimensional positioning mode can be further increased.

The present invention is not limited to the embodiment. Various improvements and changes in the design may be made within a scope that does not depart from the gist of the present invention.

For example, in the embodiment, the altitude calculation unit 4 checks the two-dimensional coordinates (latitude, longitude) of the position of the positioning apparatus on the map to calculate the altitude of the position of the positioning apparatus, which is an example. The processing it not limited to the example and can be freely changed as appropriate. For example, the altitude calculation unit 4 may be configured to measure atmospheric pressure at the position of the positioning apparatus by use of an air pressure sensor or the like, and convert the measurement result into altitude.

Moreover, the embodiment has exemplified the configuration of including the altitude calculation unit 4 that calculates the altitude of the position of the positioning apparatus, which is an example. The configuration is not limited to the example. For example, it may be configured in such a manner as that the altitude calculation process is performed by an external device other than the positioning apparatus 100, and the positioning apparatus 100 acquires the altitude calculated by the external device in the altitude calculation process via the communication network N and sets the altitude as the tentative altitude information.

Moreover, the configuration of the positioning apparatus 100 exemplified in the embodiment is an example. The configuration of the positioning apparatus 100 is not limited to the example.

In addition, it is configured in the embodiment to achieve the functions as the distance acquisition unit, the positioning unit, the altitude acquisition unit, and the setting unit by driving the distance acquisition unit 3a, the positioning unit 3d, the altitude acquisition unit 3b, and the altitude setting unit 3c under the control of the CPU of the central control unit 1. However, the configuration is not limited to this. It may be configured in such a manner as to achieve the functions by the CPU of the central control unit 1 executing a predetermined program and the like.

In other words, a program including a distance acquisition process routine, a positioning process routine, an altitude acquisition process routine, and a setting process routine is stored in a program memory (illustration omitted) for storing a program. The CPU of the central control unit 1 may be configured to function as a unit that acquires pseudo-range information pieces indicating pseudo-ranges from the positioning apparatus to three positioning satellites S by the distance acquisition process routine. Moreover, the CPU of the central control unit 1 may be configured to function as a unit that performs the positioning process in the two-dimensional positioning mode in the positioning process routine based on the acquired pseudo-range information and the tentative altitude information at the position of the positioning apparatus. Moreover, the CPU of the central control unit 1 may be configured to function as a unit that acquires the altitude of the position of the positioning apparatus from the outside in the altitude acquisition process routine upon the positioning process. Moreover, the CPU of the central control unit 1 may be configured to function as a unit that sets the acquired altitude as the tentative altitude information in the setting process routine.

Similarly, the calculation unit may also be configured to be realized by the CPU of the central control unit 1 executing a predetermined program and the like.

Furthermore, it is also possible to apply a nonvolatile memory such as a flash memory, and a portable recording medium such as a CD-ROM, in addition to a ROM, a hard disk, and the like, as a computer-readable medium where a program to execute the above processes is stored. Moreover, a carrier wave (carrier wave) is also applied as a medium that provides data of the program via a predetermined communication line.

Some embodiments of the present invention have been described. However, the scope of the present invention is not limited to the above-mentioned embodiments, and includes the scope of the invention described in the claims and equivalents thereof.

The invention described in the claims accompanied first in the patent application is added below. The claim numbers described in the addition are as in the claims attached first to the patent application.

What is claimed is:

1. A positioning apparatus for determining positions, comprising:
a distance acquisition unit configured to acquire pseudo-range information pieces indicating pseudo-ranges from the positioning apparatus to three positioning satellites;
an altitude acquisition unit configured to acquire the altitude of the position of the positioning apparatus based on map information;
a setting unit configured to set the altitude acquired by the altitude acquisition unit as a tentative altitude at the position of the positioning apparatus; and
a positioning unit configured to perform a positioning process in a two-dimensional positioning method based on the pseudo-range information acquired by the distance acquisition unit, and the tentative altitude.

2. The positioning apparatus according to claim 1, further comprising:
a storage unit configured to store the map information; and
a calculation unit configured to check the position of the positioning apparatus determined in the positioning process on the map, and calculates the altitude of the position, wherein
the altitude acquisition unit acquires the altitude calculated by the calculation unit.

3. The positioning apparatus according to claim 2, further comprising a location information storage unit configured to store location information on the position determined by the positioning unit, wherein
the calculation unit checks the position determined by a previous positioning process by the positioning unit on the map, and calculates the altitude of the position.

4. The positioning apparatus according to claim 1, wherein
the altitude acquisition unit acquires the altitude of the position of the positioning apparatus upon every positioning process, and
the setting unit sets the altitudes acquired by the altitude acquisition unit, sequentially, as the tentative altitude.

5. A positioning method using a positioning apparatus, comprising the steps of:
acquiring pseudo-range information pieces indicating pseudo-ranges from the positioning apparatus to three positioning satellites;
acquiring the altitude of the position of the positioning apparatus from the outside;
setting the acquired altitude as a tentative altitude at the position of the positioning apparatus; and
performing a positioning process in a two-dimensional positioning method based on the acquired pseudo-range information and the tentative altitude.

6. A non-transitory computer-readable recording medium recording a program for causing a computer of a positioning apparatus to execute:
a distance acquisition function of acquiring pseudo-range information pieces indicating pseudo-ranges from the positioning apparatus to three positioning satellites;
an altitude acquisition function of acquiring the altitude of the position of the positioning apparatus from the outside;
a setting function of setting the altitude acquired by the altitude acquisition function, as a tentative altitude at the position of the positioning apparatus; and
a positioning function of performing a positioning process in a two-dimensional positioning method based on the pseudo-range information acquired by the distance acquisition function, and the tentative altitude.
